(19) United States
(12) Patent Application Publication
(10) Pub. No.: US 2007/0101881 A1
(43) Pub. Date: May 10, 2007

(54) Printing press and method for the production of newspapers

(75) Inventors: Bernhard Bitzl, Augsburg (DE); Andreas Muller, Plauen (DE); Georg Riescher, Jossnitz (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/595,083

(22) Filed: Nov. 9, 2006

(30) Foreign Application Priority Data
Nov. 10, 2005 (DE) 10 2005 053 652.2

(51) Int. Cl. B41F 13/54

(52) U.S. Cl. 101/228

(57) ABSTRACT

The printing press for producing newspapers includes several unwinders from which coldset webs can be unreeled, coldset printing couples for printing the coldset webs with coldset inks, coldset formers and a coldset folder for processing the coldset webs into longitudinally and transversely folded coldset signatures. The printing press also includes an additional unwinder from which a heatset web can be unreeled, heatset printing couples for printing the heatset web with heatset inks, a dryer for drying the printed heatset web, a heatset former and a heatset folder for processing the heatset web into a longitudinally and transversely folded heatset signature. Finally, a processing device processes the heatset signature into a magazine.

### BACKGROUND OF THE INVENTION

The invention pertains to a printing press in which at least one web can be printed with coldset inks and processed into longitudinally and transversely folded signatures and to a process for the production of newspapers.

In the field of printing presses, it is known that a web can be printed on both sides with coldset inks by the use of printing couples in a printing tower, i.e., a so-called eight-couple printing tower. In another printing tower, a different web is printed on both sides with heatset inks by the use of printing couples. After being folded longitudinally by means of formers, the two webs are brought together and processed by means of a folder into longitudinally and transversely folded newspapers. In most cases, these printing presses are two pages wide. Newspapers having magazines inserted in them, however, are not produced in this way.

Newspapers having magazines inserted in them are produced in that a first printing press is used to produce the newspaper. At a different time, i.e., during the so-called “preproduction” phase, a signature is printed on a different printing press, usually on a publication printing press. The magazine to be inserted into the newspaper is produced from this signature in a processing device. The magazine is usually added weekly or monthly to the newspaper and printed over the course of the week or month preceding the insertion. The disadvantage of this production method is that several expensive printing presses are required.

### SUMMARY OF THE INVENTION

It is an object of the invention to create a printing press and a method by means of which the technical effort required to produce newspapers with inserted magazines can be reduced.

By the simultaneous printing of at least one web with heatset inks for the production of magazines in parallel with the printing of one or more webs with coldset inks for the production of newspaper signatures, the printing for the production of newspapers with inserted magazine and the printing of the magazines can in principle take place simultaneously on a printing press for the printing of newspapers while lowering the cost of machinery. The printing press and the method create the possibility of having magazines appear daily in newspapers.

Additional features and advantages can be derived from the dependent claims in conjunction with the description.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of several exemplary embodiments.

FIG. 1 is a schematic diagram of a portion of an embodiment of a printing press according to the invention;

FIG. 2 is a schematic cross sectional view along the line II-II in FIG. 1 showing formers and folders of the printing press together with an adjacent processing device;

FIG. 3 is an enlarged schematic cross sectional view of formers and folders of another embodiment of the printing press showing the feed of partial webs to the formers;

FIG. 4 is an enlarged schematic cross sectional view of formers and folders of another embodiment of the printing press showing the feed of strands leaving one former to strands leaving another former;

FIG. 5 is an enlarged schematic cross sectional view of angle bars and formers of yet another embodiment of the printing press showing the transfer of one strand of a web to a different strand of the web;

FIG. 6 is a top view showing a printed web in direction VI according to FIG. 1;

FIG. 7, as an alternative to FIG. 6, is a top view showing a web printed with broadsheet pages; and

FIG. 8 is a perspective view of a newspaper consisting of two signatures and two magazines in pulled-apart form.

### DETAILED DESCRIPTION OF THE PRESENTLY PREFERRED EMBODIMENTS

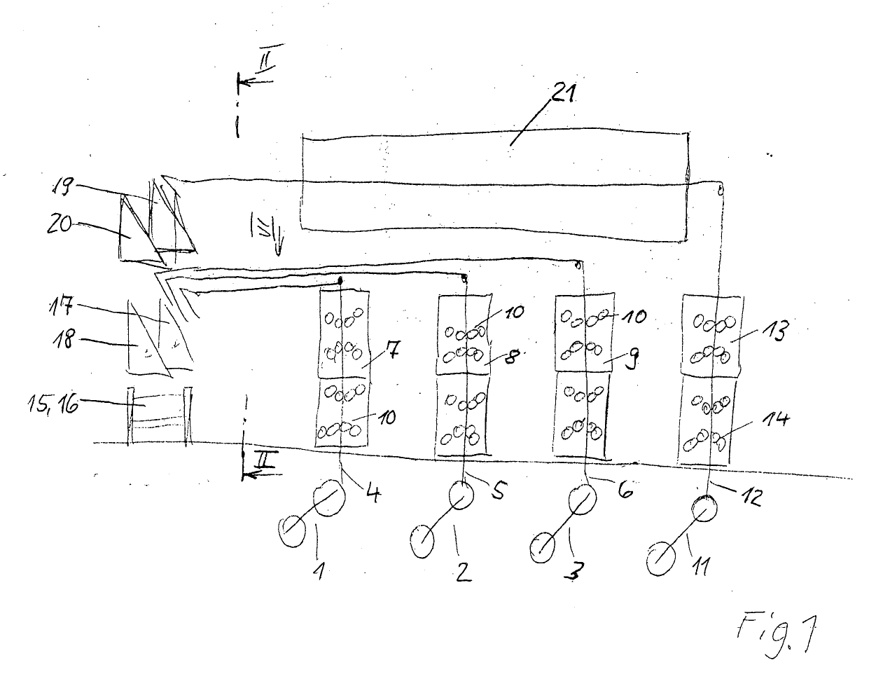

The printing press shown in FIG. 1 contains three unwinders 1, 2, 3, from each of which a web 4, 5, 6 can be pulled and sent to a printing tower 7, 8, 9. Each printing tower 7, 8, 9 contains eight printing couples 10, which process coldset inks.

Another web 12 can be pulled from another unwinder 11 and sent to a printing tower 13, which contains eight heatset ink-processing printing couples 14. Each of the printing towers 7, 8, 9, and 13 can also contain fewer than eight printing couples 10, 14.

The printing press also has a first and a second folder 15, 16, wherein, with respect to the direction of web travel, two formers 17, 18 are installed upstream of the first folder 15, and two formers 19, 20 are installed upstream of the second folder 16. The formers 19, 20 of the second folder 16 are advantageously arranged as so-called balloon formers above the formers 17, 18 of the first folder 15. The formers 17, 18 could also be assigned to the second folder 16, and the formers 19, 20 could be assigned to the first folder 15. The number of formers per folder 15, 16 has been selected merely as an example here, too. Fewer or more formers per folder can be provided, and they can be positioned on additional levels. The printing press also has a dryer 21 and the additional devices normally used for heatset printing such as a chiller and a silicone unit (not shown).

The printing couples 10 of the printing towers 7, 8, 9 work together in pairs according to, for example, the blanket-to-blanket principle for offset printing, and they thus print both sides of the web 4, 5, 6 conducted between them. The printing couples 14 of the printing tower 13 also work together in pairs.

Coldset inks are printing inks which dry by penetration into the printing material and by evaporation of their solvent. Heatset inks are printing inks which dry by the action of heat.

The web 4 unrolled from the unwinder 1 is printed in four colors on both sides in the printing tower 7. The printing press in this case is a rotary press with a width equal to four vertical newspaper pages. In a corresponding manner, the form cylinders of the printing couples 10 can be equipped with four adjacent printing forms, each of which carrying the print image of a vertical broadsheet page or two horizontal tabloid pages, one above the other. The latter option is realized in the case of the printing tower 7, in the case of the printing towers 8 and 9, and also in the case of the printing couples 14 of the printing tower 13. Correspondingly, the web 4 is printed in the printing tower 7 with tabloid pages 43 oriented horizontally with respect to the direction 45 of web travel, as shown in FIG. 6. Similarly, the web 5 is printed in printing tower 8, and the web 6 is printed in the printing tower 9.

All three webs 4, 5, 6 are laid on top of each other and sent to the formers 17, 18 of the first folder 15 (FIG. 2). The webs 4, 5, 6 are cut longitudinally at the points marked “x” in FIG. 2 by means of longitudinal cutters and then folded longitudinally as they pass over the formers 17, 18. Thus two strands 22, 23 are obtained, each of which contains signatures with 24 tabloid pages. The number of tabloid pages in the signatures is indicated by the small numbers in FIG. 2 and also in the other FIGS. 3-5 described below.

The strands 22, 23 are first stapled by means of stapling arrangements 24, 25 (stapling is indicated by dots in FIG. 2), then laid on top of each other, and sent next to the first folder 15. The latter cuts the strands 22, 23 into copies and cross-folds them, so that first and second longitudinally and transversely folded signatures 26, 27, each with 24 tabloid pages, are obtained (the longitudinal fold is cut open), wherein the second signature 27 lies inside the first signature 26. The first and second signatures 26, 27 are delivered via a paddlewheel to a conveyor belt 28 or a transport device. If no stapling is done, a common signature 26+27 is obtained. As generally known, the first folder 15 contains a cutting cylinder, a pin-tucker blade cylinder, and a jaw cylinder. The first and second signatures 26, 27 represent production, rather than preproduction. They are transported by the conveyor belt 28 to a processing device 29.

The printing couples 14 of the printing tower 13 are equipped in the same way as the printing couples 10 with four adjacent printing forms, each of which contains two horizontal tabloid pages, one above the other. The additional web 12 is therefore printed with heatset inks to form tabloid pages as it passes through the printing tower 13, as shown in FIG. 6. The additional web 12 is dried as it passes through the dryer 21 and then guided over the formers 19, 20 of the second folder 16. Before it arrives at the formers, cutting arrangements are used to make longitudinal cuts in the web at the points marked “x”. The strands 30, 31 leaving the formers 19, 20 are first stapled by stapling arrangements (not shown) and then laid on top of each other and sent to the second folder 16. Each contains one additional signature with eight tabloid pages. In the second folder 16, the strands 30 and 31 are cut into signatures, which are provided with a transverse fold. The additional signatures 32, 33 thus obtained, one inserted in the other, are delivered by paddlewheel onto a conveyor belt 34 or a transport device and sent to the processing device 29. If no stapling is done, a common signature 32+33 is obtained.

The additional signatures 32 and 33 are separated in the processing device 29 and processed into magazines 35, 36. Specifically, the additional signatures 32, 33 are subjected to a three-side trimming operation. During this operation, cuts are made on three sides all the way to the print image to remove the white margins. During printing, the white margins are already minimized to achieve a large print area and to reduce waste. The positive overlap is also kept to a minimum. The goal here is to obtain the largest possible product in which the ratio of height to width is as close as possible to the so-called “golden section” (1:1,618) and which thus corresponds to a newspaper product with a ratio of height to width which is also preferably close to the golden section. High print quality and accurate folding will also help to produce a good visual magazine impression.

It is advantageous for one of the additional signatures 32, 33 to be produced as production and one as preproduction. The printing tower 13 is for this purpose operated simultaneously in parallel with the printing towers 7, 8, and 9, but at the same or a different speed. To achieve high print quality, the printing tower 13 can be operated at a lower speed. In all embodiments of the invention, the printing couples which are printing with heatset inks can be operated either independently of or dependent on the printing couples which are printing with the coldset inks. The magazines 35, 36 obtained are inserted into the first signature 26. Previously, the first and second signatures 26, 27 can be subjected to a one-side cut in the processing device 29. This is a smoothing cut, about 3 mm deep, into the page carrying the positive overlap, the sawtooth-like cut originating from the cutting cylinder thus being removed. The finished newspapers 37 are delivered from the processing device 29 in the form of, for example, stacks 38.

A finished newspaper 37 is shown in FIG. 8, where the copies inserted into the signature 26, namely, the signature 27 and the magazines 35 and 36, are shown pulled apart from each other. The copies printed with coldset inks are designated “CS”, those printed with heatset inks “HS”. Production is designated “P”, and preproduction “VP”. It is easy to see that all the products 27, 35, 36 lie independently (not inserted into each other) next to each other in the outer signature 26.

FIGS. 3, 4, and 5 show variants for the preparation of first and second signatures 26, 27 with different numbers of pages. According to FIG. 3, webs and partial webs are sent to the formers 17 and 18 of the first folder 15. Specifically, the two webs 4 and 5 are printed with tabloid pages in the same way as that shown in FIG. 2, and after longitudinal cutting they are guided over the formers 17 and 18. Instead of the web 6, however, only a two-page-wide web 6.1, printed with tabloid pages, is guided over the former 17. The strands 22.1 and 23.1 obtained after longitudinal folding contain signatures with 24 and 16 tabloid pages, respectively. The stapling of the strands 22.1 and 23.1 by means of the stapling arrangements 24 and 25 and the further processing in the folder 15 proceed in the same way as described on the basis of FIG. 2. The additional web 12 is also guided over the formers 19 and 20, and further processing also takes place in the second folder 16 as described previously.

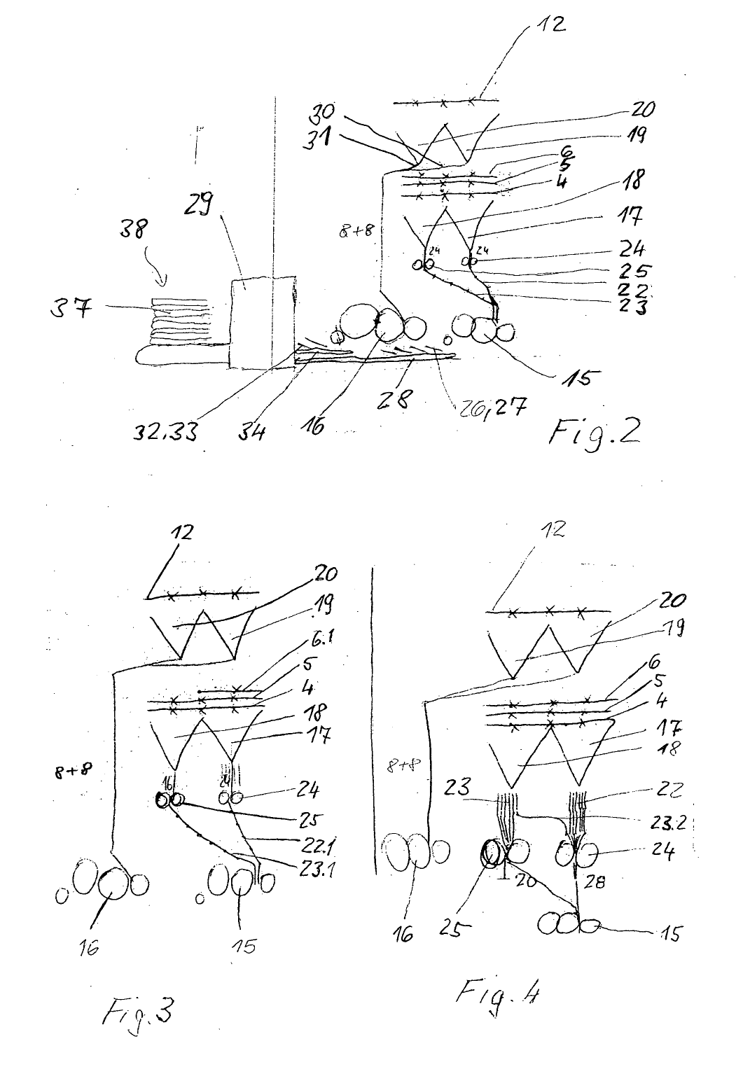

According to FIG. 4, in exactly the same way as in FIG. 2, webs 4, 5, and 6 printed with tabloid pages are sent to the two formers 17, 18. A partial strand 23.2 derived from the strand 23 leaving the former 18 is sent to the strand 22 leaving the former 17. The strands now contain signatures with 20 and 28 tabloid pages and are stapled by the stapling arrangements 24, and 25 and subjected to further processing as described on the basis of FIG. 2. As already described there, the additional web 12 is guided over the formers 19 and 20 and subjected to further processing in the second folder 16.

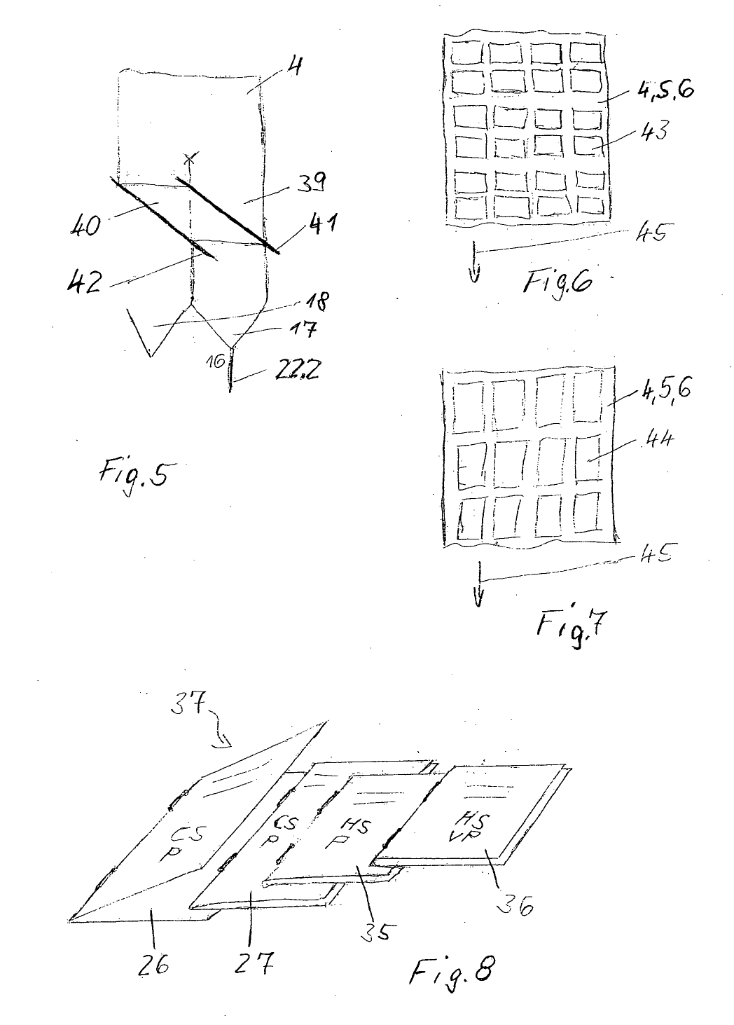

According to FIG. 5, the web 4, which has been printed on both sides with tabloid pages, is cut by a longitudinal cutting device into the web strands 39 and 40. The web strand 40 is then sent to the angle bars 41 and 42 (parallel angle bars) and laid on the web strand 39. As a result, the number of tabloid pages in the signatures of the strand 22.2 leaving the former 17 is increased by eight, and the signatures contained in strand 22.2 have 16 tabloid pages.

Of course, it is also possible to produce magazines 35, 36 having a different number of pages, similarly to the production of first and second signatures 26, 27 having a different number of pages according to FIGS. 3-5.

Instead of being printed with tabloid pages 40 which are oriented horizontally (with respect to the direction of web travel 45), as shown in FIG. 6, the webs 4, 5, and 6 can be printed on both sides with broadsheet pages 44 which are oriented vertically with respect to the direction of web travel 45, as indicated in FIG. 7. In this case, the stapling arrangements 24 and 25 shown in FIGS. 2-4 are omitted. In addition, the longitudinal cuts of the webs 4, 5, and 6 in the middle of the formers 17 and 18 are also omitted. The first and second signatures 26 and 27 produced according to FIG. 2 each then have 12 broadsheet pages. The form cylinders of the printing couples 10 printing the webs 4, 5, and 6 are equipped for this purpose with four adjacent printing forms, each of which has one vertical broadsheet page.

The invention has been explained on the basis of an example of a printing press with four vertical newspaper pages. The invention can also be applied to printing presses with a width of two or six vertical newspaper pages.

The magazines 35, 36 produced do not need to be inserted simultaneously into the newspapers printed in parallel. They can also be sent on for a different purpose; for example, they can be distributed. “Magazines” are also to be understood as magazine-like products, which do not reach the high level of print quality normally enjoyed by magazines.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing press for producing newspapers, comprising:
at least one unwinder from which at least one coldset web can be unreeled;
coldset printing couples for printing the at least one coldset web with coldset inks;
at least one coldset former and a coldset folder for processing the at least one coldset web into at least one longitudinally and transversely folded coldset signature;
at least one additional unwinder from which at least one heatset web can be unreeled;
heatset printing couples for printing the at least one heatset web with heatset inks;
a dryer for drying the at least one printed heatset web;
at least one heatset former and a heatset folder for processing the at least one heatset web into at least one longitudinally and transversely folded heatset signature; and
a processing device for processing the at least one heatset signature into at least one magazine.

2. The printing press of claim 1, wherein the coldset and heatset printing couples are operatable at a same speed or at a different speed.

3. The printing press of claim 1, wherein the processing device is designed to insert the at least one magazine into one of the at least one coldset signatures.

4. The printing press of claim 1, wherein the printing press has a width of four vertical newspaper pages, and further comprises two coldset formers assigned to the coldset folder for producing first and second coldset signatures, and two heatset formers assigned to the heatset folder for producing two heatset signatures, wherein the processing device is designed to process the two heatset signatures into two magazines and to insert the second coldset signature and the two magazines into the first coldset signature.

5. The printing press of claim 1, wherein the coldset printing couples are designed to print the at least one coldset web with vertical broadsheet or horizontal tabloid pages, and the heatset printing couples are designed to print the at least one heatset web with horizontal tabloid pages.

6. The printing press of claim 1, further comprising two coldset formers assigned to the coldset folder for producing first and second coldset signatures with numbers of pages different from each other, wherein at least one of the two coldset formers is designed to guide partial webs.

7. The printing press of claim 1, further comprising two coldset formers assigned to the coldset folder for producing first and second coldset signatures with numbers of pages different from each other, wherein the two coldset formers are designed to form web strands of the coldset webs and to guide at least one web strand leaving one of the two coldset formers to at least one web strand leaving the other one of the coldset formers before the web strands enter the coldset folder.

8. The printing press of claim 1, further comprising two coldset formers assigned to the coldset folder for producing first and second coldset signatures with numbers of pages different from each other, a cutting device for cutting the coldset web into web strands, and angle bars to lay the web strands on top of each other.

9. A process for producing newspapers with a printing press, comprising the steps of:
printing, in the printing press, at least one coldset web with coldset inks and producing at least one longitudinally and transversely folded coldset signature from the at least one coldset web;
printing, in the printing press, at least one heatset web with heatset inks, drying the at least one printed heatset web, and producing at least one longitudinally and transversely folded heatset signature from the at least one heatset web, wherein said steps of printing at least one heatset web, drying the at least one printed heatset web and producing the at least one heatset signature are performed at the same time as said steps of printing at least one coldest web and producing the at least one coldset signature; and
processing the at least one heatset signature into at least one magazine.

10. The process of claim 9, wherein the steps of printing the at least one coldset and heatset webs comprise the step of moving the at least one coldset and heatset webs at a same speed or at a different speed.

11. The process of claim 9, further comprising the step of inserting the at least one magazine into the at least one coldset signature.

12. The process of claim 9, wherein the step of producing the at least one coldset signature comprises producing first and second coldset signatures, the step of producing the at least one heatset signature comprises producing two heatset signatures, and the step of processing the at least one heatset signature into at least one magazine comprises processing the two heatset signatures into two magazines, the method further comprising the steps of inserting the second coldset signature into the first coldset signature, and inserting the two magazines into the first coldset signature.
